(19) United States
(12) Patent Application Publication
(10) Pub. No.: US 2010/0301237 A1
(43) Pub. Date: Dec. 2, 2010

(54) METHOD AND APPARATUS FOR PRODUCTION OF HEAT AND/OR MAGNETIC FIELD THROUGH PHOTON, POSITRON OR PARTICLE INFUSION

(75) Inventor: Michael S. Meyer, Louisville, KY (US)

Correspondence Address: Steve Witters, PLLC, 930 Woodland Ridge Circle, LaGrange, KY, 40031, US

(73) Assignee: INTERNATIONAL TECHNOLOGY GROUP

(21) Appl. No.: 12/473,833

(22) Filed: May 28, 2009

(51) Int. Cl. H01J 5/18

(52) U.S. Cl. 250/505.1

(57) ABSTRACT

A method and device for producing heat and/or a magnetic field through photon, positron, or particle infusion. The device includes a cylinder including a side wall having an opening extending through and tangentially to the side wall providing access to the inner side. At least a portion of the volume of the cylinder comprises neodymium glass. An induction tube may be connected to and extending from the side wall providing a passageway for a stream of particles to the neodymium glass. A lens may be positioned at an end of the induction tube opposite the connection with the cylinder and source of the stream of particles may be positioned outside and aligned with the induction tube. When the source is activated to direct the stream of photons or particles through the induction tube and into the neodymium glass in the cylinder, the source of particles in the stream are infuse into their self in the neodymium glass and release heat. The inner surface of the cylinder may be reflective causing a portion of particles escaping from the neodymium glass to be reflected back into the neodymium glass. As the particles infuse, the density of the particles within the neodymium glass increases thereby increasing the number of cycled infusions and amount of heat produced. The heat may be used to produce steam for powering a steam turbine and also produce electrical energy through magnetic induction.

### FIELD

Aspects of the present invention generally relate to methods and apparatuses for the production of heat through photon, positron, or particle infusion.

### BACKGROUND

As reflected in the patent literature, numerous types of methods and devices for the conversion of energy have been provided in the prior art. For example, U.S. Pat. Nos. 3,668,546; 4,036,012; 4,426,843; 4,612,646; 4,644,169; 4,658,115 and 5,542,247 all are illustrative of such prior art. While these units may be suitable for the particular purpose to which they address, they would not be as suitable for the purposes of the present invention as heretofore described.

U.S. Pat. No. 3,668,546, invented by Edward R. Schumacher, issued on Jun. 6, 1972, provides a laser stimulator assembly particularly suited for exciting a laser from an external position. An elongate source of laser excitation energy is positioned at the focal axis of an ellipsoidal reflector and together with cylindrical retro-reflectors and two extending plane reflectors directs the maximum amount of laser excitation energy to an elongate aperture with the minimum loss by reason of multiple reflections. The ellipsoidal reflector and the retro-reflectors are positioned within a fluid-tight enclosure comprising a body member and two end members. Communication to the inside of the fluid-tight enclosure is provided through its end members for connection of the source of actuating energy. The same communication means in the form of an electrical conductor may, in the preferred embodiment, be hollow, providing a fluid path through the end members for circulating a cooling medium through the interior of the assembly and in contact with the elongate source of laser excitation energy to increase its efficiency. The cooling medium is preferably a selected fluid having desirable light transmissive and heat conduction properties, as well as being electrically non-conductive.

U.S. Pat. No. 4,036,012, invented by Michael J. Monsler, issued on Jul. 19, 1977, discloses for optics capture and concentrate laser radiation and sending it through a gas dynamic window which is formed by supersonic expansion of unseeded hydrogen gas exiting a passageway directly under the opening. Seeded fuel is inserted into the chamber where it is heated by the laser radiation and the energy of the heated gas is converted into kinetic energy of a high velocity by means of a rocket nozzle.

U.S. Pat. No. 4,426,843, invented by Michael C. Fowler et al., issued on Jan. 24, 1984, discloses an improved energy conversion device for converting the energy carried by a laser beam to kinetic energy of a working fluid transparent to the laser radiation incorporates a seed gas having a relatively low dissipation temperature. The beam is focused to a beam spot the maximum diameter of which depends on the total power of the beam.

U.S. Pat. No. 4,612,646, invented by Bruce A. Zerr, issued on Sep. 16, 1986, discloses an improvement in gas lasers and a method of operating the same. In one aspect, the invention is an improved method for operating a high power gas laser. The improvement comprises introducing the gas lazing medium tangentially to the laser tube at a pressure establishing a forced vortex in the tube. The vortex defines an axially extending core region characterized by a low pressure and temperature relative to the gas inlet and the exterior of the vortex. An electrical discharge is established in the core region to initiate lazing of the gas. The gas discharge from the tube is passed through a diffuser. As in conventional gas lasers, firing results in a very abrupt increase in gas temperature and in severe disruption of the gas. However, the gas vortex almost immediately restores the gas to its pre-firing condition. That is, almost all of the waste heat is transferred radially to the laser wall, and the original gas-flow pattern is restored. As a result, the power output of the laser is increased significantly, and the laser firing repetition rate is markedly increased.

U.S. Pat. No. 4,644,169, invented by Stanley E. Hunt, issued on Feb. 17, 1987 discloses an apparatus for converting laser energy to thermal energy for a variety of purposes, which includes a conical laser beam collector for gathering or receiving impinging beams or rays that has a plurality of coaxially disposed annular shoulders arranged either along the external or internal surfaces of the collector adapted directly to receive the laser beams or rays. A liquid circulating system includes a cylinder housing the conical collector having a plurality of coaxial coils arranged about its internal coiled spiral carried on the conical collector. The liquid circulating system serves as a heat exchanger to convert the heat gathered by the conical collector into superheated liquid carried by the liquid circulating system for ultimate use in prime mover or generator applications.

U.S. Pat. No. 4,658,115, invented by Vernon Heath, issued on Apr. 14, 1987 discloses a method and apparatus for producing vapor from a liquid using laser energy are disclosed. Liquid within a container is vaporized by directing at least one laser beam into the liquid in the container and retaining at least essentially all of the energy of the at least one laser beam in the container for vaporizing the liquid. The container is a boiler of a high pressure steam generator in the illustrated embodiment.

U.S. Pat. No. 5,542,247, invented by Boyd B. Bushman, issued on Aug. 6, 1996 discloses a method and apparatus for converting energy into thrust, and directing the thrust to move an object. The apparatus includes a chamber having air disposed therein, a pulsed laser for converting an energy source into light pulses, and a lens for receiving the light pulses and directing the light pulses toward a focal point within the chamber. Each light pulse converges in a region which is proximate to the focal point and causes molecules within the air which are at the region to disassociate. Disassociation of the molecules generates pressure waves which provide thrust for powering the object to move.

What is needed are alternative methods and apparatus for the production of heat or a magnetic field through photon, positron, or particle infusion.

### SUMMARY

Aspects of the invention generally include a device for producing heat through photon, positron or particle infusion. The device comprises a cylinder comprising a side wall with a reflective inner surface and an inlet opening extending through and tangentially aligned with the side wall configured to provide access to the reflective inner surface of said cylinder. An induction tube may be connected to and extend from the side wall configured to provide a passageway for a stream of photons, positrons or particles into the cylinder. A source of the stream of said photons, positrons or particles is positioned at an end of the induction tube opposite the connection with the cylinder wherein the source directs the stream of photons, positrons or particles through the induction tube into the cylinder. Monolithic neodymium glass fills at least a portion of the cylinder. The device is configured to infuse at least a leading portion of the stream of photons, positrons or particles with at least a trailing portion of the stream of photons, positrons or particles, thereby occupying the same space at the same time, increasing the density of the stream of photons, positrons or particles and releasing heat.

Another aspect of the present invention discloses a method for increasing the population density of photons, positrons or particles in a stream of photons, positrons or particles. The method comprises the steps of: activating a source of the stream of photons, positrons or particles to generate the stream of photons, positrons or particles; directing the stream of photons, positrons or particles through an induction tube for entry into a into a cylinder of neodymium glass substantially surrounded by a cylinder having a mirrored inner surface; passing the stream of photons, positrons or particles through an inlet; inducting the stream of photons, positrons or particles into the cylinder of neodymium glass; reflecting at least a portion of the stream of photons, positrons or particles being released from the neodymium glass back into the neodymium glass with the mirrored inner surface of the cylinder; curving the direction of at least a portion of the stream of photons, positrons or particles about a circumference of the cylinder of neodymium glass; infusing at least a portion of the stream of photons, positrons or particles with at least one other portion of the stream of photons, positrons or particles thereby increasing the population density of the photons, positrons or particles; and harnessing at least a portion of heat released by the infusing of at least a portion of the stream of photons, positrons or particles.

In yet another aspect of the present invention, a device for producing heat through photon or particle infusion is provided. The device comprises a cylinder including a side wall and an opening extending through and tangential to the side wall providing access to the inner side of the cylinder. Monolithic neodymium glass fills a portion of the cylinder. A means for providing a stream of photons or particles into the monolithic neodymium glass through the opening in the side wall is provided. The device is configured to induct a stream of photons or particles into itself thereby causing the particles in the stream to collide and release heat within the monolithic neodymium glass.

These and other features, aspects and advantages of the present invention will become better understood with reference to the following drawings, description and claims.

### BRIEF DESCRIPTIONS OF THE DRAWINGS

The following figures, which may be idealized, may not to scale and are intended to be merely illustrative and non-limiting.

Various other objects, features and attendant advantages of the present invention will become more fully appreciated as the same becomes better understood when considered in conjunction with the accompanying drawings, in which like reference characters designate the same or similar parts throughout the several views.

FIGS. 1A-C is a flow chart describing a method for production of a device for producing heat and/or magnetic field through photon, positron, or particle infusion;

FIG. 2 is a top perspective view of material used to create a cylinder including a reflective inner surface for use with a method and a device for producing heat and/or magnetic field through photon, positron, or particle infusion;

FIG. 3 is a top view of the material used to create a cylinder including a reflective inner surface with the reflective surface polished for use with a method and a device for producing heat and/or magnetic field through photon, positron, or particle infusion;

FIG. 4 is a side perspective view illustrating the forming of a cylinder including a reflective inner surface for use with a method and a device for producing heat and/or magnetic field through photon, positron, or particle infusion;

FIG. 5 is a top perspective view of a cylinder for use with a method and a device for producing heat and/or magnetic field through photon, positron, or particle infusion;

FIG. 6 is a top perspective view illustrating the creation of an orifice in a cylinder for connection with an induction tube for use in a method and a device for producing heat and/or magnetic field through photon, positron, or particle infusion;

FIG. 7 is a top view of a cylinder including an orifice for use with a method and a device for producing heat and/or magnetic field through photon, positron, or particle infusion;

FIG. 8 is a side perspective view of a cylinder and an induction tube for use with a method and a device for producing heat and/or magnetic field through photon, positron, or particle infusion;

FIG. 9 is a top view of a cylinder and induction tube connected together for use with a method and a device for producing heat and/or magnetic field through photon, positron, or particle infusion;

FIG. 10 is a side perspective view of a cylinder and induction tube connected together with a lens positioned at an entrance to the induction tube for use with a method and a device for producing heat and/or magnetic field through photon, positron, or particle infusion;

FIG. 11 is a cross-sectional view of a cylinder and an induction tube connected together with a lens positioned at an entrance to the induction tube for use with a method and a device for producing heat and/or magnetic field through photon, positron, or particle infusion taken along the line 11-11 of FIG. 10;

FIG. 12 is a cross-sectional view of a cylinder and induction tube connected together with the condensed light source positioned at an entrance to the induction tube for use with a method and a device for producing heat and/or magnetic field through photon, positron, or particle infusion;

FIG. 13 is a cross-sectional view as shown in FIG. 12 of a method and a device for producing heat and/or magnetic field through photon, positron, or particle infusion with a stream of photons injected into the induction tube;

FIG. 14 is a cross-sectional view as shown in FIG. 12 of the method and device for producing heat and/or magnetic field through photon, positron, or particle infusion with a stream of photons traveling within the cylinder;

FIG. 15 is a cross-sectional view as shown in FIG. 12 of a method and a device for producing heat and/or magnetic field through photon, positron, or particle infusion illustrating the stream of photons colliding to increase the density of particles within the chamber; and

FIG. 16 is a cross-sectional view of an alternate embodiment of a method and a device for producing heat and/or magnetic field through photon, positron, or particle infusion.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific aspects only. In other cases it will be recognized that references to the “invention” will refer to subject matter recited in one or more, but not necessarily all, of the claims. Each of the inventions is described in greater detail below, including specific aspects, versions and examples, but the inventions are not limited to these aspects, versions or examples, which are included to enable a person having ordinary skill in the art to make and use the inventions when the information in this patent is combined with available information and technology.

Various terms as used herein. To the extent a term used in a claim is not defined herein, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable and any ranges shall include iterative ranges falling within the expressly stated ranges or limitations.

The present invention relates generally to energy conversion and, more specifically, to the generation of heat, magnetic field and/or electrical energy by the conversion of potential energy from the infusion of moving particles, positrons, or photons forming a laser or particle beam and by increasing the density of the particles forming the laser or particle beam within a cylinder of neodymium glass. A method and apparatus is disclosed for energy conversion and, more specifically, to the generation of heat and/or electrical energy by the conversion of potential energy from the infusion of moving particles, positrons, or photons forming a laser or particle beam and by increasing the density of the particles forming the laser beam within a cylinder of neodymium glass. The neodymium glass may be surrounded with a cylinder having a reflective inner surface.

Neodymium is a rare earth metal and is present in Mischmetal to the extent of about 18%. The metal has a bright, silvery metallic luster. Neodymium is a component of didymium used for coloring glass to make welder's and glass-blower's goggles. The sharp absorption bands obliterate the strong sodium emission at 589 nm. Neodymium glass may be produced by the inclusion of neodymium oxide (Nd₂O₃) in the glass melt.

Heat or other energy produced by aspects of the disclosure by way of photon or positron, etc. infusion may be use to generated steam. Other aspects of the present invention may provide methods and devices for producing heat and a magnetic field through photon or positron, etc. infusion and may be able to use the generated heat to produce electrical energy via conversion or magnetic induction. Yet further aspects of the present invention may provide a method and device for producing heat and magnetic field through photon or positron, etc. infusion wherein a laser or particle beam is directed into a cylinder having neodymium glass. Optionally, a cylinder having a reflective inner side surrounds the cylinder of neodymium glass causing portions of the laser or particle beam escaping the neodymium glass to reflect back into the neodymium glass and itself creating a high concentration of photons/positrons or particles within the neodymium glass cylinder. A still further aspect of the present invention may provide a method and device for producing heat and magnetic field through photon or positron, etc, infusion including an induction tube through which the laser or particle beam is injected into the neodymium glass cylinder. A further aspect of the present invention may provide a method and device for producing heat and magnetic field through photon or particle infusion wherein the laser or particle beam has at least a portion reflecting back against the walls of a cylinder surrounding the neodymium glass causing the photon population to multiply via particle infusion. A still further aspect of the present invention is to provide a method and device for producing heat and magnetic field through photon, positron, etc. particle infusion wherein the multiplication of the photon or positron population increases the photon density within the neodymium glass cylinder which may create intense heat and a magnetic field which may be harnessed and converted to steam for turning turbines and/or powering an electrical energy generator or charging electrical coils through magnetic induction. Another aspect of the present invention may provide a method and device for producing heat and magnetic field through photon or particle infusion that is simple and easy to use. A still further aspect of the present invention may a method and device for producing heat and magnetic field through photon or particle infusion that is economical in cost to manufacture.

A method and device for producing heat and magnetic field through photon or particle infusion is disclosed by the present invention. The device includes a cylinder of neodymium glass. Optionally, a cylinder with a side wall having a mirrored inner side and an opening extending through and tangentially to the side wall provides access to the neodymium glass and inner side of the cylinder. An induction tube may be connected to and extend from the side wall providing a passageway for a stream of particles to the neodymium glass. A lens may be positioned at an end of the induction tube opposite the connection with the cylinder and source of the stream of particles is positioned outside and aligned with the induction tube. When the source is activated to direct the stream of photons or particles through the induction tube and into the neodymium glass in the cylinder, a portion of the source of particles being emitted from the neodymium glass may be reflected off the mirrored inner side causing the particles in the stream to infuse and release heat within the neodymium glass. As the particles infuse, the density of the particles within the cylinder increases thereby increasing the number of cycled infusions and amount of heat and magnetic field produced. The heat may be used to produce steam for powering a steam turbine and also produce electrical energy or direct electricity through magnetic induction.

Aspects of this invention may be embodied in the form illustrated in the accompanying drawings, attention being called to the fact, however, that the drawings are illustrative only, and that changes may be made in the specific construction illustrated and described within the scope of the appended claims.

Turning now descriptively to the drawings, in which similar reference characters denote similar elements throughout the several views, the Figures illustrate a method and a device for producing heat and magnetic field through photon or particle infusion of aspects of the present invention. With regard to the reference numerals used, the following numbering is used throughout the various drawing figures.
10 a device for producing heat and magnetic field through photon or particle infusion
12 material used to form cylinder
14 upper reflective surface of material
16 lower surface of material
18 mirrored surface of material
20 cylinder formed by material
21 arrows representing rolling of material to form cylinder
22 seam in cylinder
24 first end of material
26 second end of material
28 top cover for cylinder
29 neodymium glass
30 bottom cover for cylinder
31 particle, positron, or photon receiver
32 first open end of cylinder
34 second open end of cylinder
36 arrows indicating movement of top cover to seal first open end
38 arrows indicating movement of bottom cover to seal second open end
40 opening formed in cylinder for introduction of laser or particle beam
42 wall of top cover
43 skirt extending from top cover
44 induction tube
46 first end of induction tube
48 lens positioned at first end of induction tube
50 source of photons or particles
52 photon or particle stream
54 photons or particles infusing within cylinder

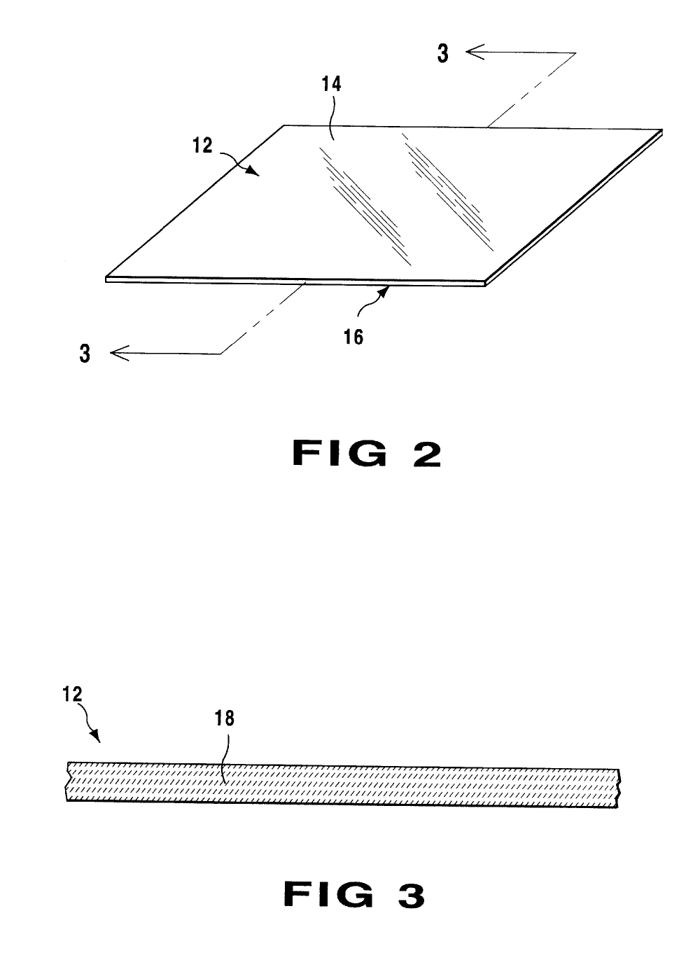

Turning now descriptively to the drawings, in which similar reference characters denote similar elements throughout the several views, FIGS. 2 through 16 illustrate a device for producing heat and/or magnetic field through photon, positron, or particle infusion of aspects of the present invention indicated generally by the numeral 10.

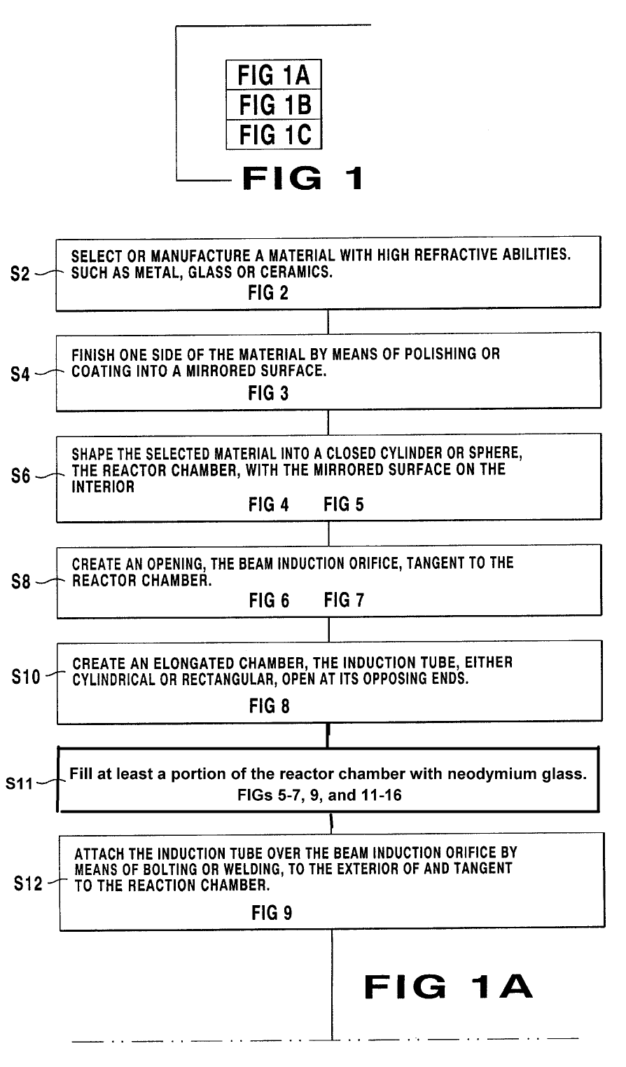

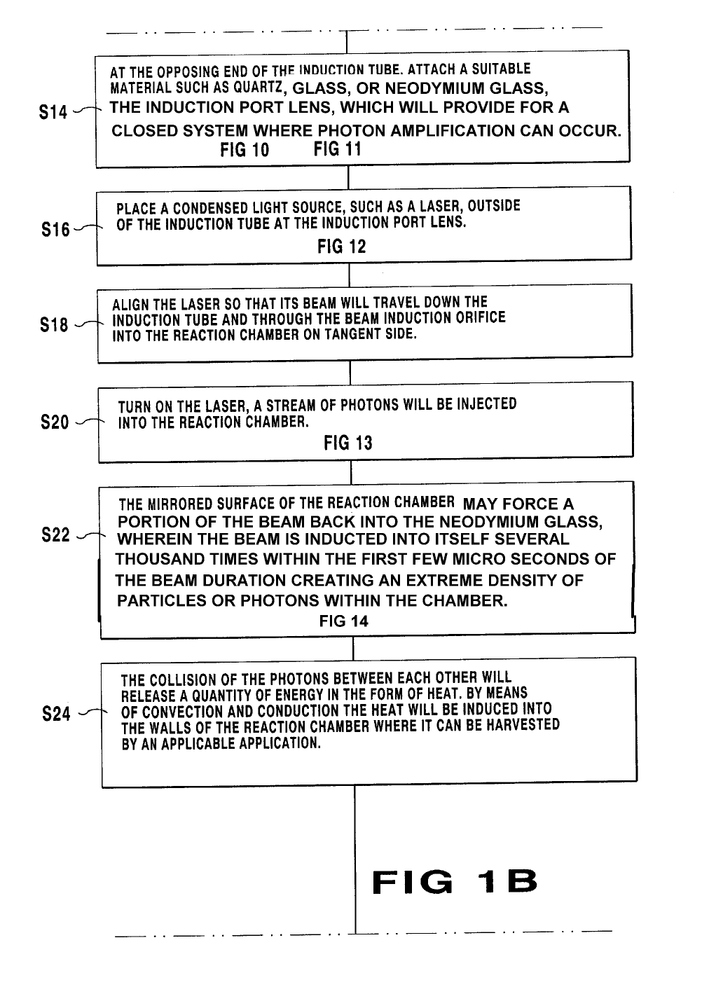

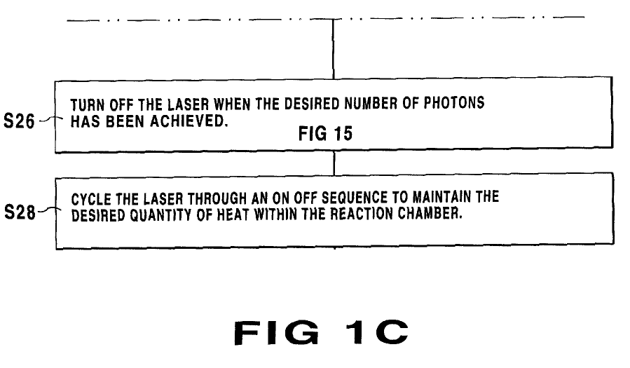

A device for producing heat and magnetic field through photon or particle infusion 10 is illustrated in FIGS. 2-16 showing the formation of the device in a progressive fashion with a corresponding description of the formation and method of use in FIG. 1. FIG. 2 illustrates a flat piece of material 12 which may have highly reflective properties. The material 12 is used to form a cylinder as will be explained hereinafter. The material 12 used is preferably formed from at least one of metal, glass, ceramic, any metal alloy and any combination thereof. The material 12 may have an upper reflective surface 14 and a lower surface 16. The upper reflective surface 14 may be polished or coated to form a mirrored surface 18 as illustrated in FIG. 3.

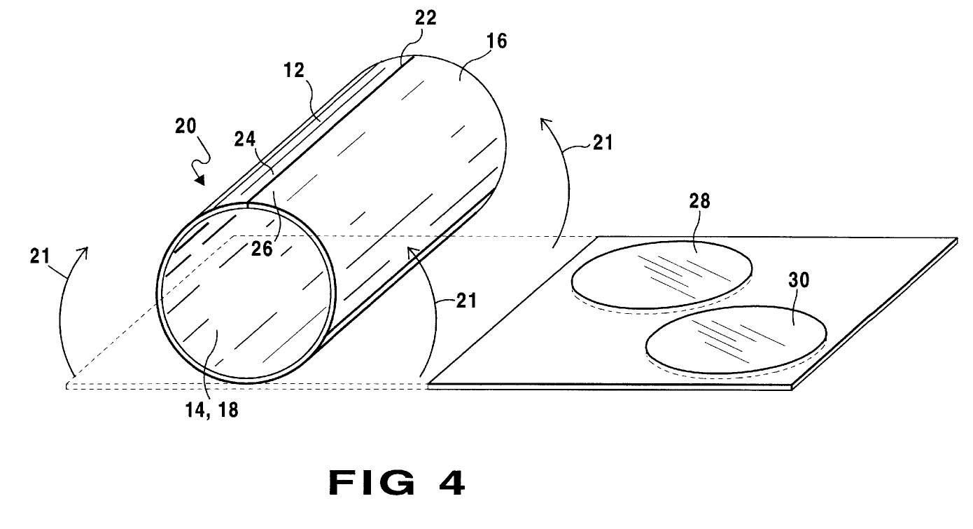

The flat piece of material 12 may then be cut to a preferred size and rolled to form a cylinder 20 as indicated by the arrows labeled 21 in FIG. 4. The material 12 may be rolled such that the mirrored surface 18 forms the inner side of the cylinder 20. A seam 22 formed in the cylinder 20 indicates where the first and second ends 24 and 26, respectively, of the material 12 are sealed together. The seam 22 is sealed closed such as by soldering to completely close the side wall of the cylinder 20. A top cover 28 and a bottom cover 30 for the cylinder 20 may be formed from a portion of unused material 12. The top and bottom covers 28 and 30 have a circumference substantially equal to the circumference of the cylinder 20. The top cover 28 may be formed with a skirt 43 depending therefrom.

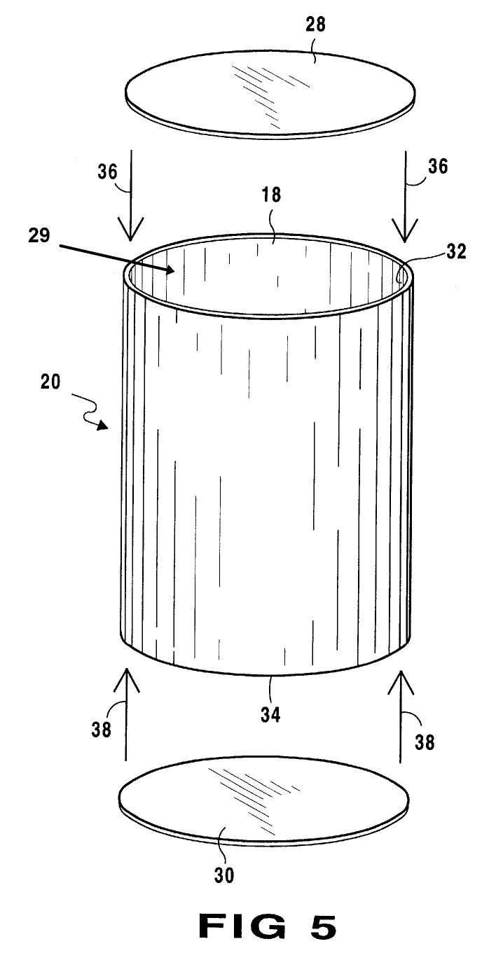

Placement of the top and bottom covers 28 and 30, respectively, to cover the first and second open ends 32 and 34, respectively, of the cylinder 20 is illustrated in FIG. 5. In one aspect, top cover 28 isn't secured to an open end until molten neodymium glass 29 is poured into cylinder 20 and cured to form a monolithic cylinder of neodymium glass in cylinder 20. From this view it can be seen that when the flat piece of material 12 is rolled to form the cylinder 12, first and second open ends 32 and 34, respectively, are formed. The top and bottom covers 28 and 30, respectively, are formed from the spare material are positioned to cover the first and second open ends 32 and 34 and thereby seal the cylinder 20. The top cover 28 is positioned to cover the first open end 32 as indicated by the arrows labeled 36 and the bottom cover 30 is positioned to cover the second open end 34 as indicated by the arrows labeled 38.

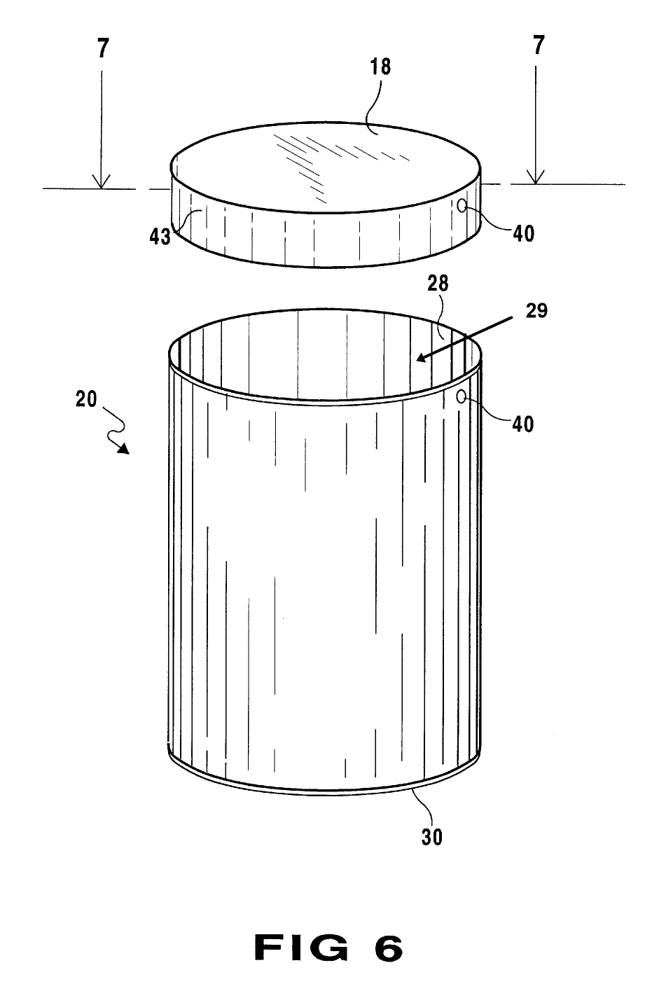

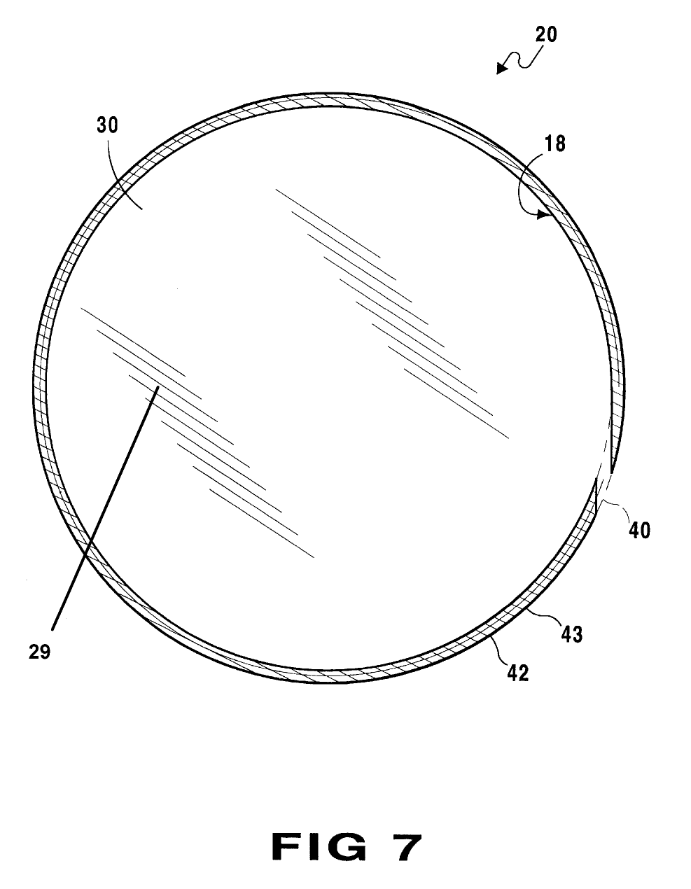

An opening 40 is then created in a side of the top cover 28 and top side 32 of the cylinder 20 as illustrated in FIGS. 6 and 7 for introduction of the particle stream forming the laser or particle beam into the cylinder 20. FIG. 6 illustrates a perspective view of the cylinder 20 and top cover 28 while FIG. 7 illustrates a cross-sectional view. The opening 40 is at an angle to the wall 42 forming a skirt 43 extending through the top cover 28 and cylinder 20 so as to be substantially tangential to the wall 42 of both the top cover 28 and the cylinder 20 as is clearly seen in FIG. 7. Alternately, the opening 40 may be formed at a top side of the cylinder 20 adjacent the open first end 32 and below the top cover 28. Forming the opening 40 in this manner controls the direction at which the laser or particle beam will enter the neodymium glass 29 in cylinder 20 and thus may control an angle of reflection within the cylinder 20.

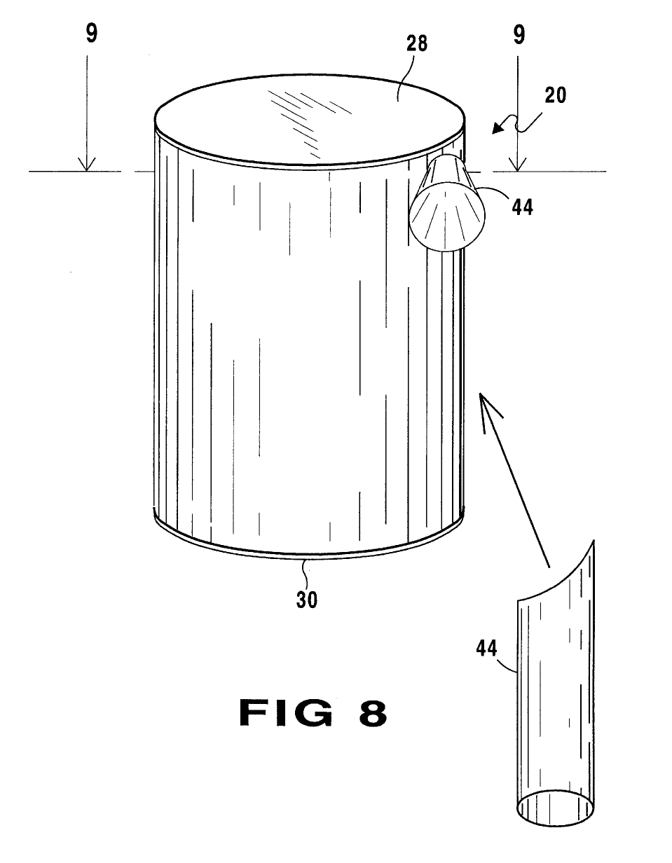

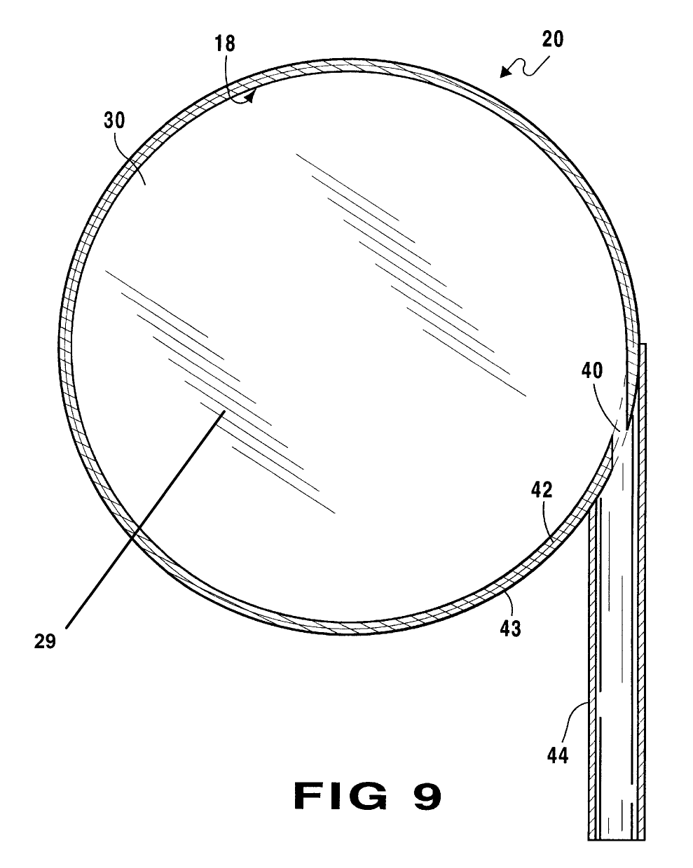

An induction tube 44 may be formed and positioned to cover the opening 40 as illustrated in FIGS. 8 and 9. The induction tube 44, in this aspect, is in the form of an elongated chamber providing a path to the opening 40 through which the laser or particle beam may travel. The induction tube 44 is optional and may be one of cylindrical and rectangular in shape. The induction tube 44 may be connected to the skirt 43 of the top cover 28 or to the top side 32 of the cylinder 20 through either bolts or a weld. Furthermore, the induction tube 44 extends at substantially the same angle to the cylinder wall 42 as the opening 40.

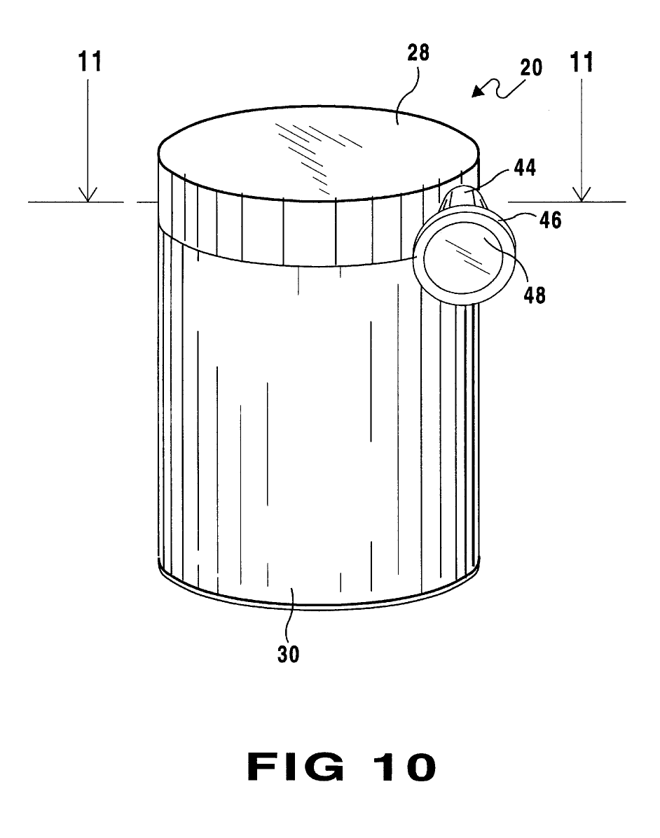

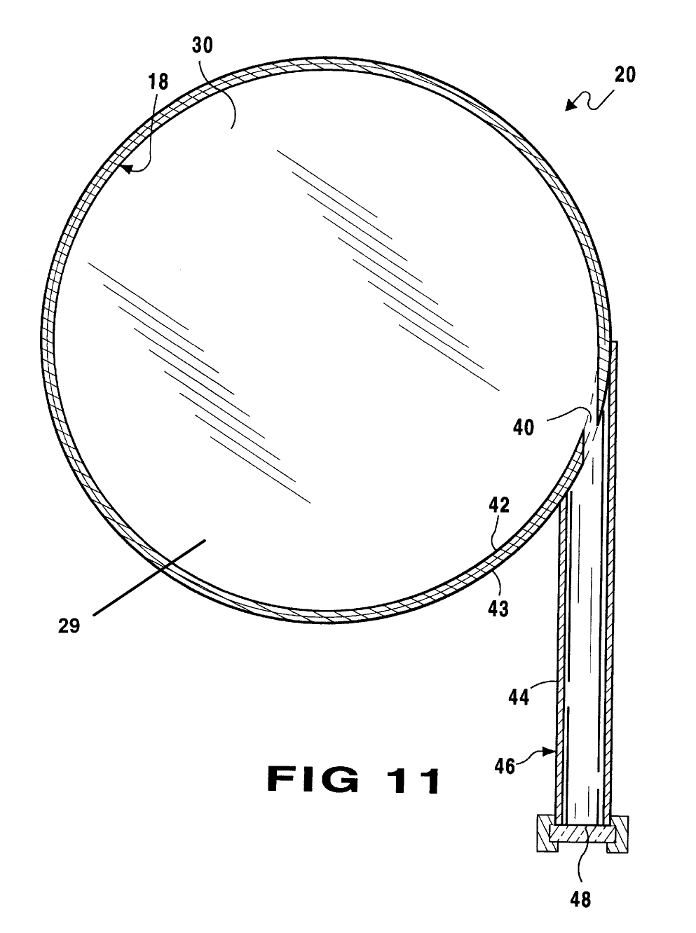

At a first end 46 of the induction tube 44 opposite the connection to the top cover 28 may have a lens 48 as is illustrated in FIGS. 10 and 11. The lens 48 is preferably formed of one of quartz, glass, neodymium glass, and any combination thereof and any material which will close the passageway through the induction tube 44 and provide the path of the photon stream forming the laser or particle beam passing therethrough.

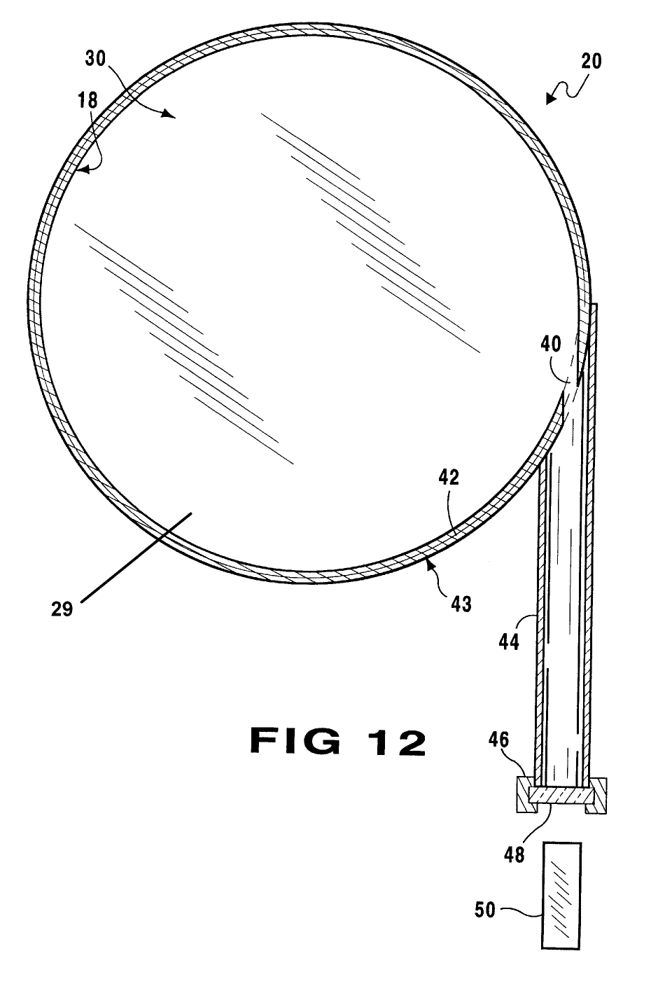

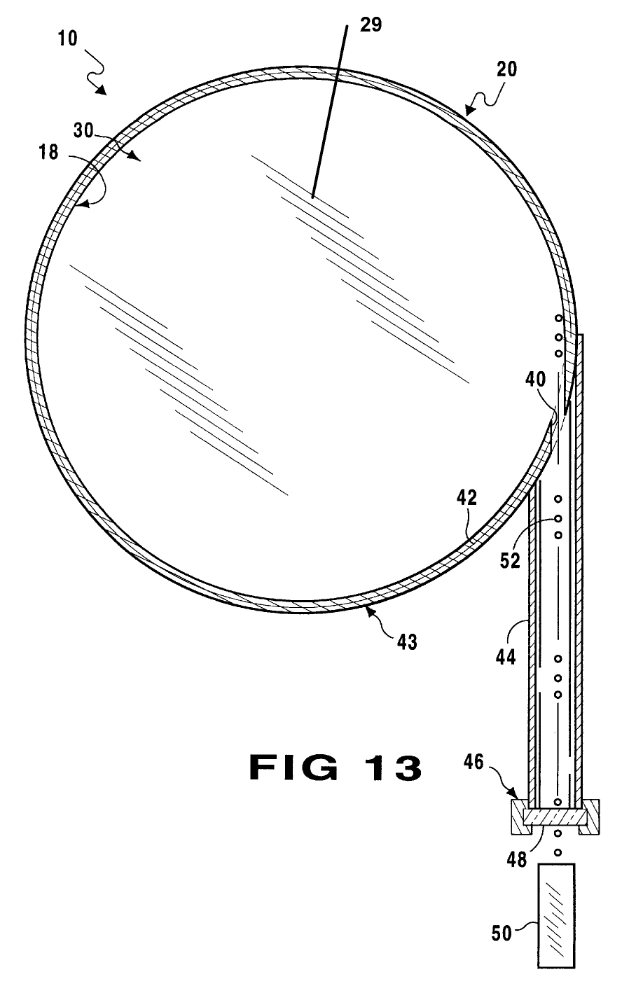

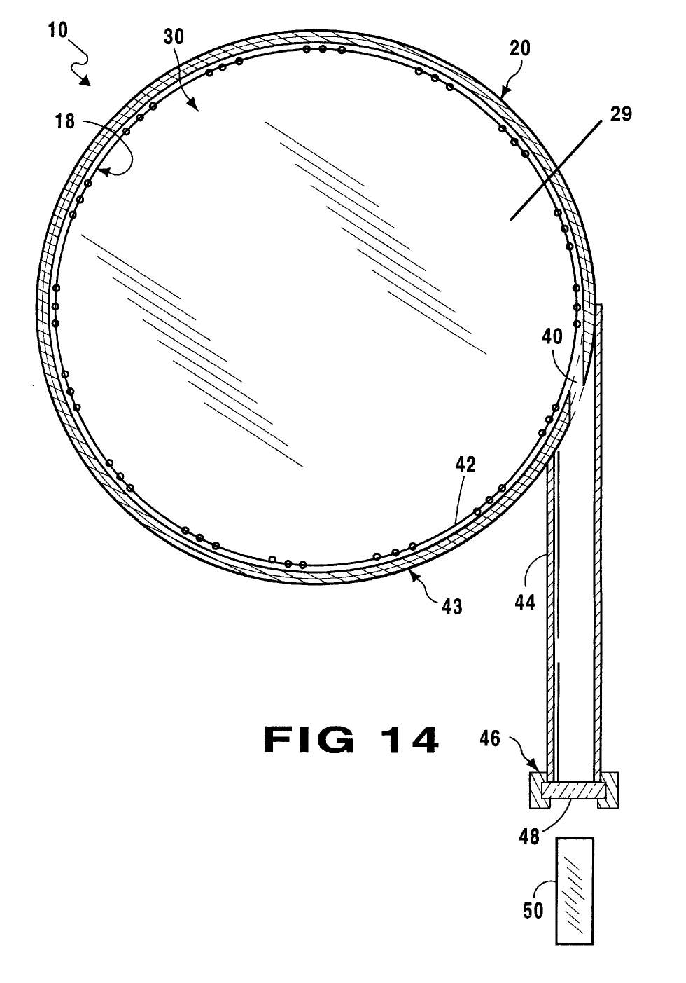

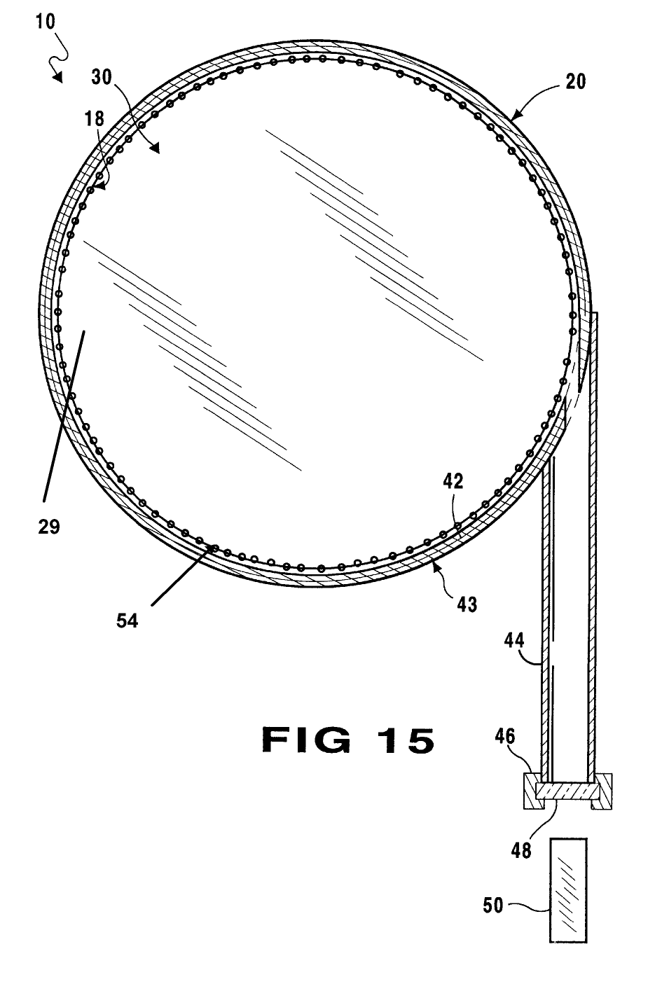

FIGS. 12-15 illustrate positioning of the source 50 of the laser or particle beam positioned outside the lens 48. The source 50 of condensed light forming the laser or particle beam is positioned in front of the lens 48 and outside the induction tube 44. The source 50 is in alignment with the induction tube 44 such that when the laser beam is produced, the photons or particles 52 forming the laser or particle beam will travel through the induction tube 44 through the opening 40 and into neodymium glass 29 in the cylinder 20 as illustrated in FIG. 13. The photons or particles 52 will then travel substantially within neodymium glass 29 in the cylinder 20 and a portion may be reflected within the cylinder 20 against the mirrored surface 18 back into neodymium glass 29 as illustrated in FIG. 14. The mirrored surface 18 may cause a portion of the beam 52 to be reflected back into itself causing the density of photons or particles within neodymium glass 29 in the cylinder 20 to increase at an exponential pace thereby greatly increasing the density of photons or particles within neodymium glass 29 as illustrated in FIGS. 14 and 15. The increased number of photons or particles 54 will continue to travel within the neodymium glass 29 and a portion may be reflected off of the mirrored surface 18 until the source 50 is turned off. The cycled infusion of the photons or particles 54 travel within the neodymium glass 29 and by the reflections off of the mirrored surface may cause the release of energy stored therein in the form of heat. The heat emitted from the photons or particles 54 may be absorbed by the neodymium glass 29 and the walls of the cylinder 20 through convection and conduction where it may be harvested for use at a later time such as for the production of steam for use in powering a steam turbine engine or for powering an electrical generator to generate electrical energy via energy conversion or magnetic induction.

The source 50 may be turned off upon generation of a desired amount of heat, i.e. obtaining a desired number of photons or particles infusing within the cylinder. The source 50 may then be cycled through an on/off sequence to maintain the amount of heat generated and account for dissipation of heat into the ambient atmosphere.

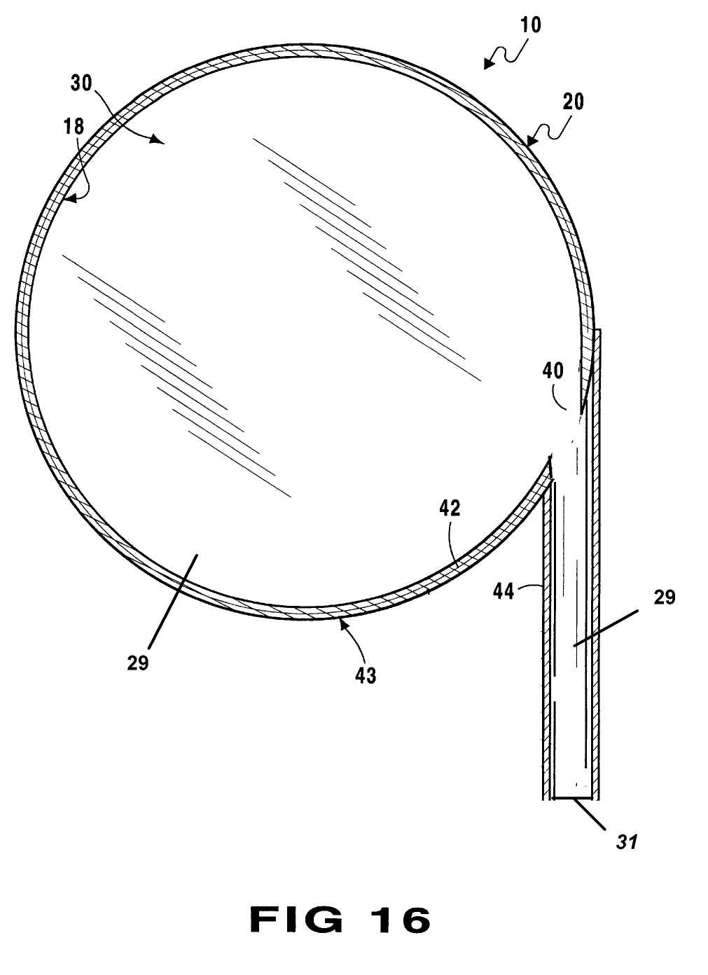

FIG. 16 shows an aspect of the present invention having a monolithic neodymium glass cylinder portion in cylinder 20 and an induction portion induction tube 44. Advantageously, the cylindrical portion and the induction portion are comprised of single monolithic piece of neodymium glass 29. Particle, positron, or photon receiver 31 receives the particle stream and directs the stream into the cylindrical portion of neodymium glass 29 through the induction portion of neodymium glass 29. In the embodiment shown here, receiver 31 is substantially flat, however, it is to be understood that receiver 31 may be convex, concave, or have a different lensing shape. In this embodiment, cylinder 20 having inner mirror surface 18 may be optional as a substantial portion of the stream of particles, positrons, or photons may be retained within the cylindrical portion of neodymium glass 29. Further, top wall cover 42, bottom wall cover 30, and induction tube 44 may also be optional or may be removed after forming the monolithic cylindrical and induction portions of neodymium glass 29. Additionally, opening 40 in this embodiment has a diameter substantially equal to the inner diameter of induction tube 44.

The production and operation of the device for producing heat and magnetic field through photon, particle infusion 10 will now be described with reference to the figures and specifically FIG. 1. In operation, the device for producing heat and magnetic field through photon, particle infusion 10 may be produced from a flat piece of material 12 having highly refractive properties as described in step S2. The material 12 used is preferably formed from at least one of metal, glass, ceramic, any metal alloy and any combination thereof. The material 12 has an upper reflective surface 14 and a lower surface 16, the upper reflective surface 14 may be polished or coated to form a mirrored surface 18 as stated in step S4.

The flat piece of material 12 may then be cut to a preferred size and shaped by rolling to form a cylinder 20. The material 12 may be rolled such that the mirrored surface 18 forms the inner side of the cylinder 20 as discussed in step S6. The sides of the material may be sealed together by soldering or with bolts, for example, to completely enclose the inner side of the cylinder 20. A top cover 28 and a bottom cover 30 for the cylinder 20 may be formed from a portion of unused material 12. The top and bottom covers 28 and 30 have a circumference substantially equal to the circumference of the cylinder 20 and are placed to cover the first and second open ends 32 and 34, respectively, of the cylinder 20 covering the first and second open ends 32 and 34 and thereby enclosing the cylinder, 20.

An opening 40 is then created in a side of the top cover 28 and through the cylinder 20 for introduction of the particle stream forming the laser or particle beam into the cylinder 20 as described in step S8. The openings 40 will be aligned with one another thereby creating an entry into the cylinder 20 for the laser beam to pass through. Alternatively, the opening may be positioned at a top side 32 of the cylinder 20 below the top cover 28. The opening 40 is formed to extend at an angle to the wall 42 forming a skirt 43 extending from the top cover 28 so as to be substantially tangential to the wall 42 of both the top cover 28 and the cylinder 20. Alternately, the opening 40 may be formed at a top side 32 of the cylinder 20 adjacent the open first end 32. Forming the opening 40 in this manner may help control the direction at which the laser beam will enter the cylinder 20 and thus the angle of reflection within the cylinder 20.

An elongated chamber having open end sides is then formed to operate as an induction tube 44 as stated in step S10. The induction tube 44 is then attached to the cylinder 20 in a position covering the opening 40 as discussed in step S12. The induction tube 44 is connected to the skirt 43 of the top cover 28 or to the top side of the cylinder 20. A lens 48 may be attached to a first end 46 of the induction tube 44 opposite the connection to the top cover 28 as described in step S14. The lens 48 is preferably formed of one of quartz, glass, neodymium glass, and any combination thereof and any material and provides an entrance through which an amplified photon stream forming the laser beam can pass into and through the induction tube.

At step S11, at least a portion of the reactor chamber or cylinder 20 is filled with neodymium glass. Advantageously, cylinder 20 acts as a mold for receiving molten neodymium glass which is then allowed to cool and solidify into a monolithic cylinder. Optionally, induction tube 44 is also filled with molten neodymium to form a single monolithic glass cylinder and induction tube. Lens 48 may serve to form a particle, positron, or photon receiver 31 in the induction portion of the neodymium glass 29 and optional may be removed upon solidification of molten neodymium glass 29.

The source 50 of the laser or particle beam is then positioned outside the induction tube 44 and in front of the lens 48 as stated in step S16. The source 50 is then aligned with the induction tube 44 such that when the laser or particle beam is produced, the photons 52 forming the laser or particle beam will travel through the induction tube 44 through the opening 40 and into the cylinder 20 as stated in step S18.

The device for producing heat and magnetic field through photon, particle infusion 10 is now ready for use. The source 50 will now be turned on to create a stream of photons or particles 52 which will travel through the induction tube 44 and into the cylinder as discussed in step S20. The mirrored surface 18 within the cylinder may cause a portion of the stream of photons or particles escaping neodymium glass 29 to be reflected within the cylinder 20 against the mirrored surface 18, and back into neodymium glass 29. The neodymium glass 29 and mirrored surface 18 may cause the beam 52 to be refracted and reflected back into itself causing the density of photons or particles within the cylinder 20 to increase at an exponential pace thereby greatly increasing the density of photons or particles within the cylinder 20 as stated in step S22. The infusion of the photons or particles forming the stream may cause the release of energy stored therein in the form of heat. The heat emitted from the photons or particles 54 will be absorbed by the walls of the cylinder 20 through convection and conduction where it may be harvested for use at a later time such as for the production of steam for use in powering a steam turbine engine or for powering an electrical generator to generate electrical energy via energy conversion as described in step S24.

The source 50 will be turned off upon generation of a desired amount of heat, i.e. obtaining a desired number of photons or particles infusing within the cylinder as discussed in step S26. The source 50 may then be cycled through an on/off sequence to maintain the amount of heat generated and account for dissipation of heat into the ambient atmosphere as stated in step S28.

The following patent is hereby incorporated by reference as if set forth in its entirety herein: U.S. Pat. No. 6,000,223, entitled “METHOD AND APPARATUS FOR PRODUCTION OF HEAT AND/OR MAGNETIC FIELD THROUGH PHOTON OR POSITRON INFUSION”, filed Sep. 21, 1998, issued Dec. 14, 1999, by Michael S. Meyer.

The purpose of incorporating U.S. patents applications and other publications is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

From the above description it can be seen that the method and device for producing heat and magnetic field through photon, particle infusion of the present invention may be able to overcome shortcomings of prior art devices by providing a method and device for producing heat and/or magnetic field through photon, positron, or particle infusion which may able to generate heat by converting the energy stored in a laser beam, the heat produced by the laser beam may be used to produce steam or generate electrical energy. The method and device for producing heat through photon-positron or particle infusion directs the laser beam through an induction tube and into a cylinder having a reflective inner side which causes the laser beam to reflect back into itself creating a high concentration of photons or particles within a cylinder of neodymium glass. The method and device for producing heat through particle infusion provides for the laser or particle beam to continually reflect back against the walls of the cylinder thereby causing the photon or particle population to multiply, the multiplication of the photon population increasing the photon density within the neodymium cylinder and creating intense heat. Furthermore, the method and device for producing heat through photon/particle infusion of the present invention may be simple and easy to use and may be economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A device for increasing the density of photons, positrons or particles through photon, positron or particle infusion, said device comprising:
a) a cylinder comprising a side wall with a reflective inner surface and an inlet opening extending through and tangentially aligned with said side wall configured to provide access to said reflective inner surface of said cylinder;
b) an induction tube connected to and extending from said side wall configured to provide a passageway for a stream of said photons, positrons or particles into said cylinder;
c) a source of said stream of said photons, positrons or particles positioned at an end of said induction tube opposite said connection with said cylinder wherein said source directs said stream of photons, positrons or particles through said induction tube into said cylinder;
d) monolithic neodymium glass filling at least a portion of said cylinder; and
e) said device being configured to infuse at least a leading portion of said stream of photons, positrons or particles with at least a trailing portion of said stream of photons, positrons or particles, thereby occupying the same space at the same time, increasing the density of said stream of photons, positrons or particles within said monolithic neodymium glass.

2. The device for increasing the density of photons, positrons or particles of claim 1 further comprising chrome-moly on said reflective inner surface of said cylinder.

3. The device for increasing the density of photons, positrons or particles of claim 1 further comprising a source of said stream of said photons, positrons or particles positioned at an end of said induction tube opposite said connection with said cylinder wherein said source is configured to direct said stream of said photons, positrons or particles through said induction tube and said passage way into said cylinder.

4. The device as recited in claim 1, further comprising a lens positioned in or proximate said induction tube wherein said lens is configured to direct said stream of said photons, positrons or particles passing therethrough and into said monolithic neodymium glass.

5. The device as recited in claim 1, wherein said lens is formed from one of quartz, glass, neodymium glass, and any combination thereof.

6. The device as recited in claim 1, wherein said cylinder is formed from a refractive material.

7. The device as recited in claim 4, wherein said refractive material is one of metal, any metal alloy, glass, ceramic material and any combination thereof.

8. The device as recited in claim 1, wherein said induction tube is one of cylindrical and rectangular.

9. The device as recited in claim 1, wherein said induction tube is connected to said cylinder by one of bolting or welding.

10. The device as recited in claim 1, wherein said stream of particles is formed of photons.

11. A method for increasing the population density of photons, positrons or particles in a stream of photons, positrons or particles, comprising the steps of:
activating a source of said stream of photons, positrons or particles to generate said stream of photons, positrons or particles;
directing said stream of photons, positrons or particles through an induction tube for entry into a into a cylinder of neodymium glass substantially surrounded by a cylinder having a mirrored inner surface;
passing said stream of photons, positrons or particles through an inlet;
inducting said stream of photons, positrons or particles into said cylinder of neodymium glass;
reflecting at least a portion of said stream of photons, positrons or particles being released from said neodymium glass back into said neodymium glass with said mirrored inner surface of said cylinder;
curving the direction of at least a portion of said stream of photons, positrons or particles about a circumference of said cylinder of neodymium glass;
infusing at least a portion of said stream of photons, positrons or particles with at least one other portion of said stream of photons, positrons or particles thereby increasing the population density of said photons, positrons or particles; and
harnessing at least a portion of heat released by the infusing of at least a portion of said stream of photons, positrons or particles.

12. The method as recited in claim 11, further comprising the step of passing the stream of photons, positrons or particles through a lens in an induction tube configured to amplify the stream of photons, positrons or particles.

13. The method as recited in claim 11, further comprising the step of deactivating the source of the stream of photons, positrons or particles upon harnessing a desired amount of heat.

14. The method as recited in claim 13, further comprising the step of reactivating the source of the stream of photons, positrons or particles upon dissipation of the harnessed heat to a level below the desired amount of heat.

15. The method as recited in claim 1, further comprising the step of using the harnessed heat to heat water and thereby produce steam

16. The method as recited in claim 15, further comprising the step of activating a steam turbine with the steam produced by heating water.

17. The method as recited in claim 1, further comprising the step of converting the harnessed heat into electrical energy.

18. A device for increasing the population density of photons, positrons or particles in a stream of photons, positrons or particles through infusion, said device comprising:
a cylinder of monolithic neodymium glass;
a particle, positron, or photon receiver configured to receive a stream of photons, positrons, or particles and deliver said stream of photons, positrons or particles into said cylinder of monolithic neodymium glass;
said particle, positron, or photon receiver being configured to deliver said stream of photons, positrons or particles into said cylinder of monolithic neodymium glass tangentially with an outer circumference of said monolithic neodymium glass; and
wherein cylinder of monolithic neodymium glass is configured to induct said stream of photons, positrons or particles into itself thereby causing said particles in said stream to collide and release heat within said monolithic neodymium glass.

19. The device as recited in claim 18, wherein said cylinder of monolithic neodymium glass and said particle, positron, or photon receiver are together comprised of a single piece of monolithic neodymium glass.

20. The device as recited in claim 18 wherein said particle, positron, or photon receiver comprises a lens configured to collect said stream of photons, positrons or particles.
